(19) United States
(12) Patent Application Publication
(10) Pub. No.: US 2023/0046227 A1
(43) Pub. Date: Feb. 16, 2023

(54) COOKING RECIPE DISPLAY SYSTEM, COOKING RECIPE DISPLAY METHOD, PROGRAM, AND INFORMATION TERMINAL

(71) Applicant: Panasonic Intellectual Property Management Co., Ltd., Osaka (JP)

(72) Inventors: HIROKI YAMADA, Shiga (JP); YASUHIRO YUKI, Kanagawa (JP); MASAFUMI SADAHIRA, Shiga (JP); YUKI TAOKA, Kyoto (JP)

(21) Appl. No.: 17/758,600

(22) PCT Filed: Feb. 25, 2021
(86) PCT No.: PCT/JP2021/007133

§ 371 Date: Jul. 11, 2022

(30) Foreign Application Priority Data
Feb. 27, 2020 (JP) 2020-031171

(51) Int. Cl. G06F 40/109; G06F 3/16; G06F 3/0482; G06F 3/0484; G06F 40/295; G06F 16/35

(52) U.S. Cl. CPC G06F 40/109; G06F 3/165; G06F 3/0482; G06F 3/0484; G06F 40/295; G06F 3/167; G06F 16/353

(57) ABSTRACT

Cooking recipe display system (100) is provided with database (11), extraction unit (21a), emphasis unit (21b), and output unit (23). Database (11) stores a plurality of cooking recipes each being expressed in natural language sentences. Extraction unit (21a) extracts one or more recipe terms from the natural language sentences constituting one cooking recipe selected from the plurality of cooking recipes. Emphasis unit (21b) determines an emphasis method for the one or more recipe terms. Output unit (23) outputs the one cooking recipe with the one or more recipe terms emphasized according to the emphasis method determined by emphasis unit (21b).

### TECHNICAL FIELD

The present disclosure relates to a cooking recipe display system.

### BACKGROUND ART

Recently, there has been constructed a cooking recipe display system that displays a cooking recipe on an information terminal such as a smart phone or a tablet computer. In this system, a user can search for a site on which a cooking recipe is posted, or download a cooking recipe from that site, using the Internet.

In such a cooking recipe display system, Patent Literature 1 discloses technique that displays a cooking recipe, which is expressed in natural language sentences, on an information terminal.

### CITATION LIST

### Patent Literature

PTL 1: Unexamined Japanese Patent Publication No. 2019-87116

### SUMMARY OF THE INVENTION

A cooking recipe, which is expressed in natural language sentences, includes recipe terms such as ingredients used for cooking, a quantity of the ingredients, cooking action for cooking, and cookware. For this reason, if a user views a cooking recipe for the first time, or if a user is inexperienced in cooking, it will be difficult for the user to understand contents of the cooking recipe displayed on the information terminal.

In the cooking recipe display system disclosed in Patent Literature 1, ingredients and working contents are classified for each cooking process of a cooking recipe and displayed. Furthermore, in this system, ingredients, working processes, and quantity are displayed in different colors for each classified area. Thus, a user can easily understand a cooking recipe in this system, as compared with a cooking recipe without being classified or color-coded.

If a user is different, however, recipe terms to which attention is paid in a cooking recipe will be different. Therefore, in the cooking recipe display system disclosed in Patent Literature 1, an easily understandable cooking recipe for all users may not necessarily be displayed.

The present disclosure aims to provide a cooking recipe display system, a cooking recipe display method, a program, and an information terminal that are capable of displaying a cooking recipe in a suitable manner for each user.

A first aspect of the present disclosure is a cooking recipe display system. The cooking recipe display system of the present aspect is provided with a database, an extraction unit, an emphasis unit, and an output unit.

The database stores a plurality of cooking recipes, each being expressed in natural language sentences. The extraction unit extracts one or more recipe terms from natural language sentences constituting one cooking recipe selected from the plurality of cooking recipes stored in the database.

The emphasis unit determines an emphasis method for the one or more recipe terms. The output unit outputs the one cooking recipe with the one or more recipe terms emphasized according to the emphasis method determined by the emphasis unit.

A second aspect of the present disclosure is a cooking recipe display method. The cooking recipe display method of the present aspect includes a step that extracts one or more recipe terms from natural language sentences constituting one cooking recipe that is selected from the plurality of cooking recipes, each being expressed in natural language sentences.

The display method of the present aspect further includes a step that determines an emphasis method for the one or more recipe terms, and a step that outputs the one cooking recipe with the one or more recipe terms emphasized according to the determined emphasis method.

A third aspect of the present disclosure is a program for causing a computer to execute the above-mentioned cooking recipe display method.

A fourth aspect of the present disclosure is an information terminal. The information terminal of the present aspect is provided with an extraction unit, an emphasis unit, and an output unit. The extraction unit extracts one or more recipe terms from natural language sentences constituting one cooking recipe selected from a plurality of cooking recipes, each being expressed in the natural language sentences.

The emphasis unit determines an emphasis method for the one or more recipe terms. The output unit outputs the one cooking recipe with the one or more recipe terms emphasized according to the emphasis method determined by the emphasis unit.

According to each aspect of the present disclosure, the cooking recipe can be displayed in a suitable manner for each user.

### BRIEF DESCRIPTION OF DRAWINGS

FIG. 1 is a view schematically showing a cooking recipe display system in accordance with an exemplary embodiment.

FIG. 2 is a block diagram showing a configuration of the cooking recipe display system in accordance with the exemplary embodiment.

FIG. 3 is a view showing an example of a format of a cooking recipe in the cooking recipe display system.

FIG. 4 is a view showing another example of the format of the cooking recipe in the cooking recipe display system.

FIG. 5 is a view showing an example of a classification table in the cooking recipe display system.

FIG. 6 is a view showing an example of a terminological variation table in the cooking recipe display system.

FIG. 7 is a view showing an example of an emphasis table in the cooking recipe display system.

FIG. 8 is a view showing another example of the emphasis table in the cooking recipe display system.

FIG. 9 is a view showing an example of a substitutable term table in the cooking recipe display system.

FIG. 10 is a view showing an example of an association emphasis table in the cooking recipe display system.

FIG. 11 is a view showing a first concrete example of a display screen of a cooking recipe in which recipe terms are highlighted.

FIG. 12 is a view showing a second concrete example of the display screen of the cooking recipe in which recipe terms are highlighted.

FIG. 13 is a view showing a third concrete example of the display screen of the cooking recipe in which recipe terms are highlighted.

FIG. 14 is a view showing a fourth concrete example of the display screen of the cooking recipe in which recipe terms are highlighted.

FIG. 15 is a view showing a fifth concrete example of the display screen of the cooking recipe in which recipe terms are highlighted.

FIG. 16 is a view showing a sixth concrete example of the display screen of the cooking recipe in which recipe terms are highlighted.

FIG. 17 is a view showing a seventh concrete example of the display screen of the cooking recipe in which recipe term are highlighted.

FIG. 18 is a view showing an eighth concrete example of the display screen of the cooking recipe in which recipe terms are highlighted.

FIG. 19 is a view showing a ninth concrete example of the display screen of the cooking recipe in which recipe terms are highlighted.

FIG. 20 is a view showing an example of a first emphasis table in the ninth concrete example.

FIG. 21 is a view showing an example of a second emphasis table in the ninth concrete example.

FIG. 22 is a view showing a tenth concrete example of the display screen of the cooking recipe in which recipe terms are highlighted.

FIG. 23 is a view showing an eleventh concrete example of the display screen of the cooking recipe in which recipe terms are highlighted.

FIG. 24 is a view showing a twelfth concrete example of the display screen of the cooking recipe in which recipe terms are highlighted.

FIG. 25 is a view showing an example of a cooking know-how expression table in the twelfth concrete example.

FIG. 26 is a view showing a thirteenth concrete example of the display screen of the cooking recipe in which recipe terms are highlighted.

FIG. 27 is a view showing an example of an emphasis table in the thirteenth concrete example.

FIG. 28 is a view for explaining an example of a display function of an information terminal in the cooking recipe display system.

### DESCRIPTION OF EMBODIMENTS

Hereinafter, exemplary embodiments of the present disclosure will be described. Each exemplary embodiment described in the following indicates one concrete example of the present disclosure. In the following exemplary embodiments, a numerical value, components, arrangement and connection of the components, steps, an order of the steps, and the like will be described as an example.

### Cooking Recipe Display System

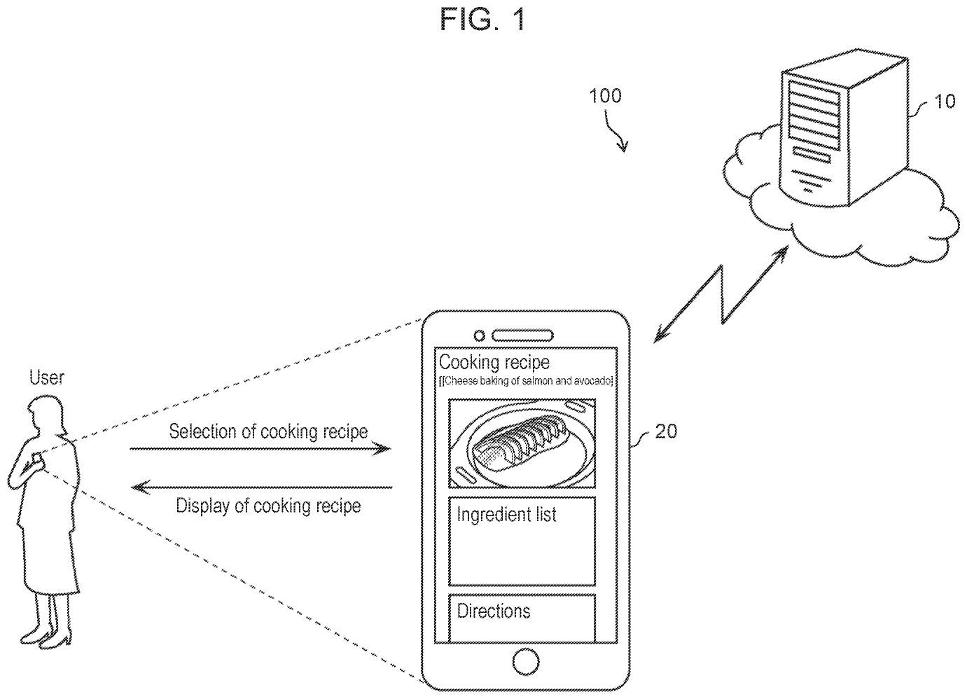

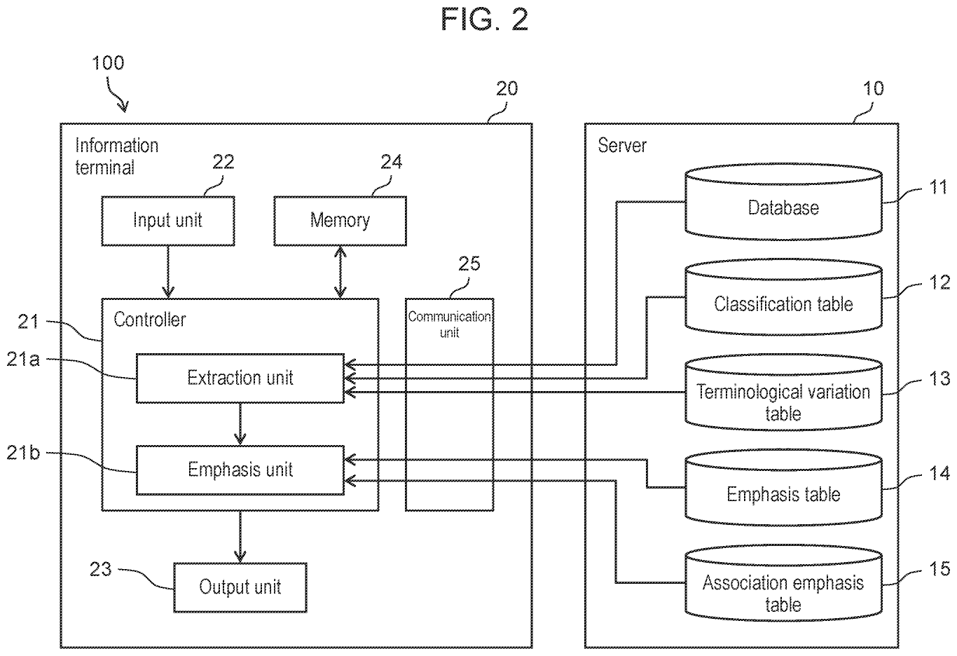

The entire configuration of cooking recipe display system 100 in accordance with the present exemplary embodiment will be described with reference to FIGS. 1 and 2. FIG. 1 is a view schematically showing cooking recipe display system 100. FIG. 2 is a block diagram showing a configuration of cooking recipe display system 100.

As shown in FIGS. 1 and 2, cooking recipe display system 100 is provided with server 10 and information terminal 20. Server 10 is a web server. Information terminal 20 is connected to server 10 through a network such as the Internet.

Server 10 is a cooking-recipe providing server that provides a cooking recipe. Server 10 may be either a cloud server or a physical server. Server 10 may produce or manage a cooking recipe as well as provide a cooking recipe. In FIG. 2, server 10 is a component separated from information terminal 20. However, the function of server 10 may be included in information terminal 20.

As shown in FIG. 2, server 10 has database 11 that stores data related to a plurality of cooking recipes. Database 11 is stored in a storage device included in server 10, for example.

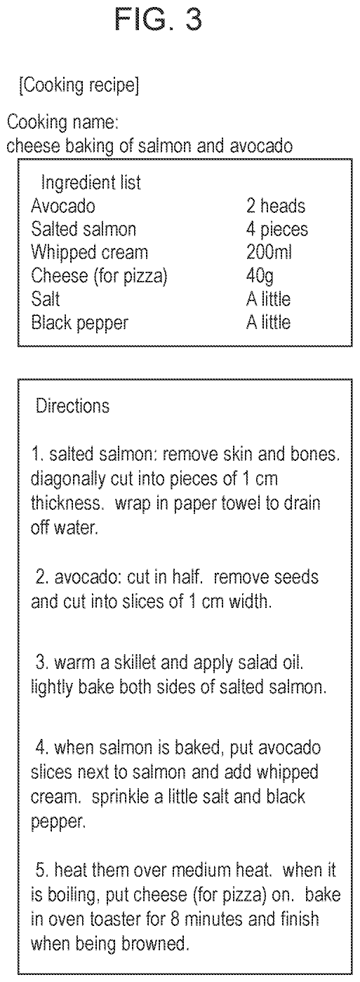

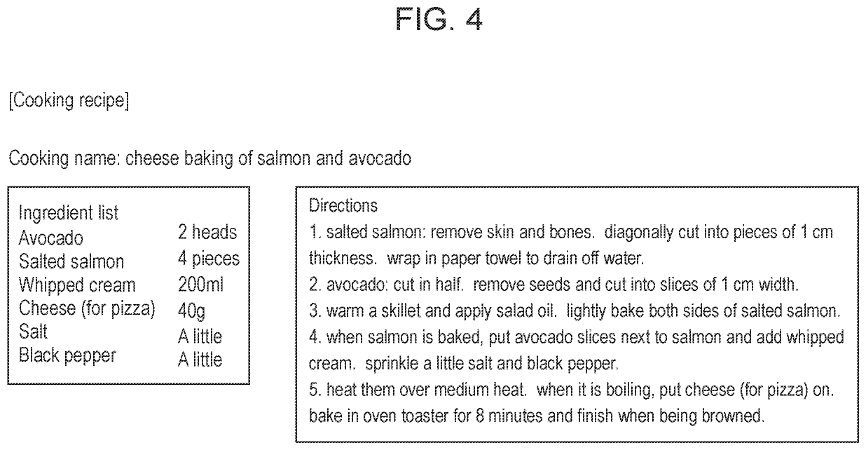

The plurality of cooking recipes, which are stored in database 11, each are expressed in natural language sentences. FIGS. 3 and 4 exemplarily show a format of the cooking recipe in the cooking recipe display system. As shown in FIG. 3, each cooking recipe includes a ingredient list indicating cooking ingredients, and a plurality of procedures (cooking procedure) indicating cooking directions.

Each cooking recipe includes one or more recipe terms. Specifically, the ingredient list and the procedure each include the one or more recipe terms. The cooking recipe includes a photograph or an illustration showing an image of cooking. Dishes cooked by using the cooking recipe may be food or drink.

In each cooking recipe, the cooking ingredients include foods and seasoning used for cooking. In the ingredient list, a quantity of ingredients is described, as well as the ingredients itself.

In each cooking recipe, a plurality of procedures, which indicate detections, are described for each cooking process. The plurality of procedures, each having an order expressed by a numeral, are described while being divided into paragraphs, for example. By cooking according to the procedures shown in the cooking recipe, a user can make desired dishes.

For instance, FIG. 3 exemplarily shows the case where cooking is performed by five procedures. In FIG. 3, numerals of “1”, “2”, “3”, “4”, and “5” are given to procedure 1, procedure 2, procedure 3, procedure 4, and procedure 5, respectively. As shown in FIG. 3, ingredients listed in the ingredient list are used to be cooked according to procedure 1, procedure 2, procedure 3, procedure 4, and procedure 5 in this order. Thus, the cooking can be finished.

FIG. 3 exemplarily shows a cooking recipe of which a cooking name is “cheese baking of a salmon and an avocado.” FIG. 3 exemplarily shows a cooking recipe of a vertical displaying format (portrait display format) on assumption that a user views a display screen of a smart phone in a vertical orientation. When a user views a display screen of a smart phone in a horizontal orientation, a horizontal displaying format (landscape display format), shown in FIG. 4, is used. Hereinafter, the cooking recipe of which a cooking name is “cheese baking of a salmon and an avocado” will be described using the horizontal displaying format.

Database 11 stores such a plurality of cooking recipes. In database 11, a new cooking recipe may be added and recorded, or an old cooking recipe may be deleted. The cooking recipe stored in database 11 is appropriately updated as necessary. The cooking recipe may be updated by a user of cooking recipe display system 100, although being usually updated by an administrator of server 10.

As shown in FIG. 2, server 10 further has classification table 12, terminological variation table 13, emphasis table 14, and association emphasis table 15. These tables are stored in a storage device included in server 10, for example. These tables may be stored in database 11.

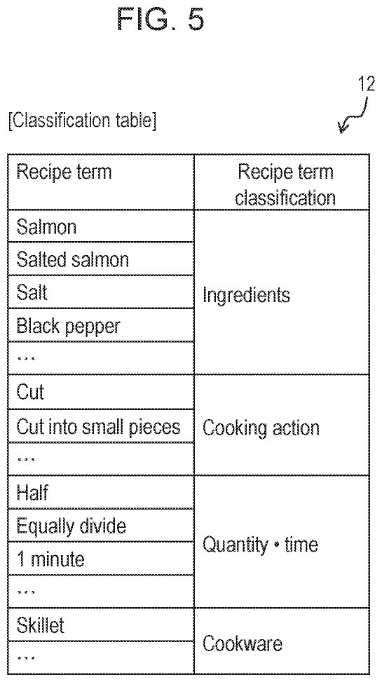

Classification table 12 includes a plurality of recipe term classifications that are classified in advance according to a type of recipe term. FIG. 5 shows an example of classification table 12. As shown in FIG. 5, classification table 12 defines a correspondence between a recipe term and a recipe term classification. In the present exemplary embodiment, the recipe term classification includes “ingredients,” “cooking action,” “quantity and time,” and “cookware.” The ingredients are foods and seasoning used for cooking, as mentioned above. The cooking action is user's behavior when the ingredients are used to be cooked. The quantity is a quantity of ingredients used for cooking. The time is time required for cooking (cooking time) when the ingredients are used to be cooked. The cookware is a tool used for cooking foods, e.g., includes a frying pan, a pan, a kitchen knife, and the like.

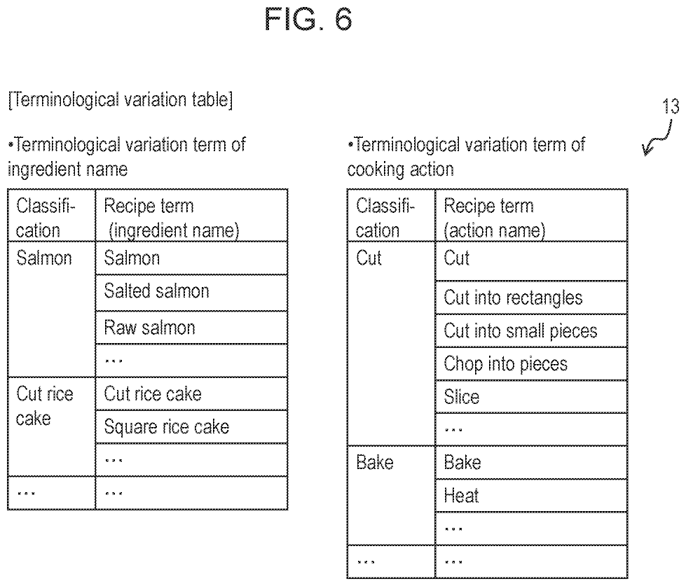

Terminological variation table 13 includes a plurality of terminological variation terms with respect to a natural language of one standard recipe term, which is used as a standard. The terminological variation term in a cooking recipe is a recipe term that has different expressions but the same meaning among recipe terms included in natural language sentences constituting the cooking recipe. FIG. 6 shows an example of terminological variation table 13. As shown in FIG. 6, terminological variation table 13 includes a table indicating terminological variation terms for a recipe term of an ingredient name, and a table indicating terminological variation terms for a recipe term of cooking action.

Emphasis table 14 includes an emphasis method of a recipe term included in a cooking recipe. Emphasis table 14 stores in advance information indicating how the recipe term, which is included in a cooking recipe, is highlighted. Specifically, emphasis table 14 specifies a relationship between the recipe term, which is included in a cooking recipe, and the emphasis method.

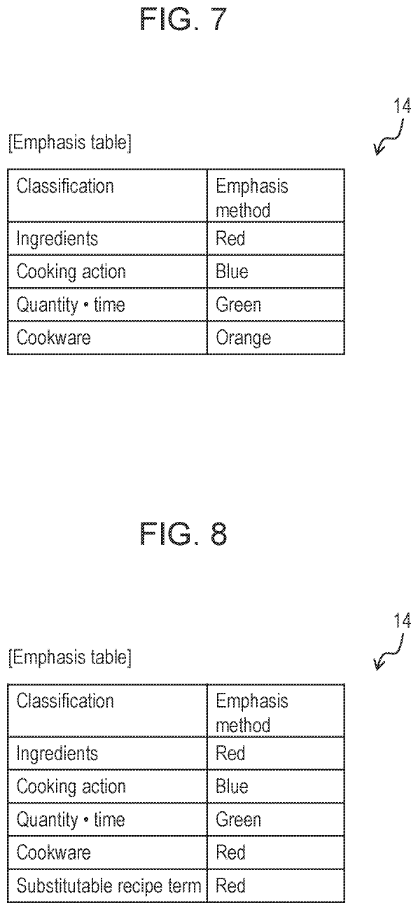

In the present exemplary embodiment, emphasis table 14 includes a plurality of emphasis methods each being determined in advance for each of the plurality of recipe term classifications. FIGS. 7 and 8 show an example of emphasis table 14. As shown in FIG. 7, emphasis table 14 defines a different color for each of the plurality of recipe term classifications as an emphasis method. In other words, emphasis table 14 defines a relationship between a predetermined color, which indicates a recipe term classification, and an emphasis method. One or more kinds of colors may be used for emphasis table 14. The same color may be used for two or more recipe term classifications among the plurality of recipe term classifications, or may be used for all of them. However, it is desired that a different color is used for each of the plurality of recipe term classifications.

Natural language sentences of a cooking recipe may include a substitutable recipe term that can be substituted by other objects or other matters as a recipe term. In this case, emphasis table 14 may also include an emphasis method adapted for the substitutable recipe term, as shown in FIG. 8. To determine whether natural language sentences of a cooking recipe include the substitutable recipe term or not, a substitutable term table, shown in FIG. 9, can be used. For instance, server 10 stores the substitutable term table. As shown in FIG. 9, the substitutable term table defines a substitutable recipe term and one or more substituted recipe terms corresponding to the substitutable recipe term.

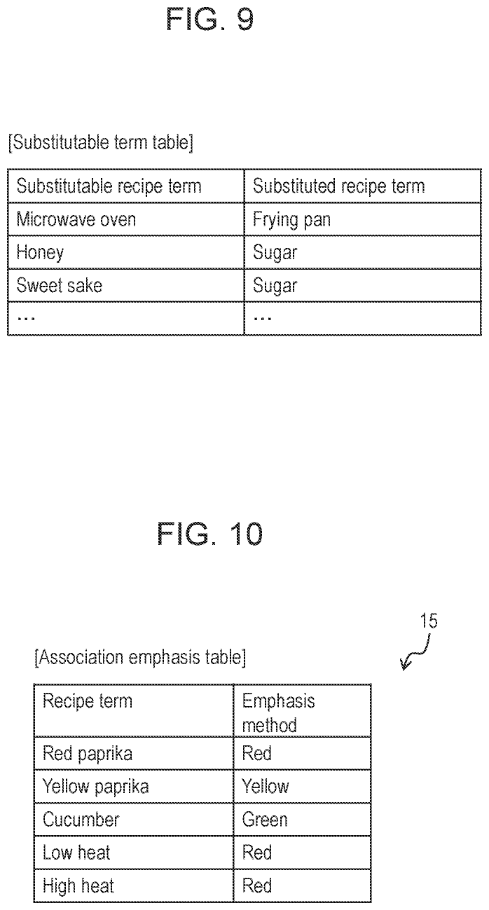

Association emphasis table 15 defines a correspondence between a recipe term and a color or an icon that is associated with the recipe term. As an example, as shown in FIG. 10, association emphasis table 15 defines a correspondence between a recipe term and a color that is associated with the recipe term as an emphasis method. For instance, a red paprika, which is one of recipe terms related to foods, has a red appearance. Therefore, the emphasis method, corresponding thereto, is set to a red color. The terms of “low heat” and “high heat,” which are one of recipe terms related to cooking action, have a relation to fire. Therefore, the emphasis method, corresponding thereto, is set to a red color.

The data, which are stored in classification table 12, terminological variation table 13, emphasis table 14, and association emphasis table 15, may be updated appropriately. A recipe term classification may be performed in the following manner: the minimum necessary recipe terms are prepared in advance and learning is performed by using a user's use history, importing data, or the like to speculate the recipe term classification.

Next, information terminal 20 will be described. Information terminal 20 is an electronic device that has a display screen. Information terminal 20 is a portable information processing device such as a smart phone, a tablet computer, or a notebook type of personal computer, or a stationary information processing device such as a desktop type of personal computer or a signage, for example. In the present exemplary embodiment, information terminal 20 is a smart phone that has a display device in which a display screen and an operation screen are combined to be used, as shown in FIG. 1. Information terminal 20 has a network connection function. As shown in FIG. 1, by accessing server 10 through information terminal 20, a user can select one cooking recipe from a plurality of cooking recipes, and display the cooking recipe on the display screen of information terminal 20.

Information terminal 20 has controller 21, input unit 22, output unit 23, memory 24, and communication unit 25.

Controller 21 controls information terminal 20. For instance, controller 21 controls input unit 22, output unit 23, memory 24, and communication unit 25 to cause information terminal 20 to perform various kinds of functions. Specifically, controller 21 has a memory storing a program such as an application program, a processor executing the program, an input/output port, and the like. For instance, by causing the processor to execute the program stored in the memory, controller 21 performs various control. The processor is constituted by a MPU (micro processing unit), a CPU (central processing unit), a DSP (digital signal processor), a GPU (graphical processing unit), an SOC (system on a chip), or the like, for example.

Controller 21 has extraction unit 21a and emphasis unit 21b as a functional component achieved by causing the processor to execute the program.

Extraction unit 21a extracts one or more recipe terms from natural language sentences constituting data of one cooking recipe selected from data of the plurality of cooking recipes stored in database 11. In the present exemplary embodiment, extraction unit 21a extracts a plurality of recipe terms from the natural language sentences constituting the one cooking recipe.

Specifically, extraction unit 21a analyzes a cooking recipe such that natural language sentences, which express one cooking recipe selected by a use, are subjected to natural language processing such as a morphological analysis (Morphological analysis). Extraction unit 21a further extracts a plurality of recipe terms, which are included in the natural language sentences of the cooking recipe, from the cooking recipe. In the present exemplary embodiment, one or more recipe terms extracted by extraction unit 21a are ingredient information, cooking action information, a quantity of ingredients, cooking time, cookware information, and the like, for example.

The plurality of recipe terms extracted by the extraction unit 21a are classified according to a classification table. For instance, extraction unit 21a classifies the plurality of recipe terms, which are extracted from the cooking recipe, into any of four types of classifications, i.e., “ingredients,” “cooking action,” “quantity and time,” and “cookware” with reference to classification table 12 shown in FIG. 5.

Emphasis unit 21b determines an emphasis method for the one or more recipe terms extracted by extraction unit 21a. In the present exemplary embodiment, extraction unit 21a extracts a plurality of recipe terms from one cooking recipe. Therefore, emphasis unit 21b determines an emphasis method for each of the plurality of recipe terms extracted by extraction unit 21a.

Specifically, emphasis unit 21b classifies each of the plurality of recipe terms, which is extracted by extraction unit 21a, into any of a plurality of recipe term classifications, with reference to classification table 12. Emphasis unit 21b further determines an emphasis method for each of the plurality of recipe term classifications, with reference to emphasis table 14.

The emphasis method determined by emphasis unit 21b is any one of a character color, a character thickness, a character size, a character font, and decoration insertion of an alternative icon, for example. For instance, if a character color is employed as the emphasis method, emphasis unit 21b will refer to emphasis table 14 shown in FIG. 7. The plurality of recipe terms, which are classified into “ingredients,” “cooking action,” “quantity and time,” and “cookware” according to emphasis table 14 shown in FIG. 7, are highlighted in red, blue, green, and orange, respectively.

Emphasis unit 21b may determine an emphasis method for each of a plurality of recipe terms with reference to terminological variation table 13. In this case, emphasis unit 21b specifies a standard recipe term for each of the one or more recipe terms, which are extracted by extraction unit 21a, with reference to terminological variation table 13. Emphasis unit 21b further determines an emphasis method for each of the plurality of recipe terms extracted by extraction unit 21a such that, among the one or more recipe terms, a recipe term specified as the same standard recipe term is emphasized according to the same emphasis method.

According to a user's cooking skill, emphasis unit 21b may determine an emphasis method for one or more recipe terms extracted by extraction unit 21a.

Input unit 22 accepts an input from a user. Input unit 22 may accept an emphasis method for a recipe term from a user. In other words, an emphasis method for a recipe term of a cooking recipe, which is displayed on a display screen of information terminal 20, may be freely selectable for a user. For instance, to enable a user to select which one of a character color, a character thickness, a character size, a character font, and the like is set as an emphasis method, manual operation buttons indicating these selections may be displayed on a display screen.

To enable a user to select emphasis methods (e.g., color) for a plurality of recipe term classifications, manual operation buttons having a plurality of colors, which indicate the selections, may be displayed on a display screen. In this case, emphasis unit 21b determines an emphasis method for one or more recipe terms, which are extracted by extraction unit 21a, according to the emphasis method accepted in input unit 22.

Input unit 22 is a user interface operated by a user. For instance, if information terminal 20 is a smart phone, input unit 22 will be constituted by a touch panel. On the touch panel, a GUI (Graphical user interface) screen, which is suitable for user's touch operation, is displayed. Input unit 22 is not limited to the touch panel, but may be an input device such as a mouse, a keyboard, a touchpad, or a microphone.

Output unit 23 outputs one cooking recipe selected from a plurality of cooking recipes with one or more recipe terms emphasized according to the emphasis method determined by emphasis unit 21b. In the present exemplary embodiment, emphasis unit 21b determines an emphasis method for each of the plurality of recipe terms extracted by extraction unit 21a. Therefore, output unit 23 outputs one cooking recipe selected from the plurality of cooking recipes with each of the plurality of recipe terms emphasized according to the emphasis method determined by emphasis unit 21b.

Specifically, extraction unit 21a extracts a plurality of recipe terms from one cooking recipe. Output unit 23 outputs the cooking recipe with each of the plurality of recipe terms emphasized according to the emphasis method determined by emphasis unit 21b.

In the present exemplary embodiment, output unit 23 is a display unit that has a display screen. As an example, output unit 23 is a display device such as a liquid crystal display device. Output unit 23 displays an entire cooking recipe, while emphasizing one or more recipe terms by using a color or the like according to the emphasis method determined by emphasis unit 21b. If information terminal 20 is a smart phone, input unit 22 and output unit 23 will be constituted as one touch panel.

Memory 24 is a storage unit that stores various kinds of data and programs. Memory 24 may store a cooking recipe downloaded from server 10, for example. Memory 24 may store an extraction result extracted by extraction unit 21a and a result determined by emphasis unit 21b. Memory 24 may be used as a working memory of controller 21.

Memory 24 includes a primary storage device such as a RAM (random access memory) or a ROM (read only memory), for example. Memory 24 may include either or both of a secondary storage device, such as an HDD (hard disc drive) or an SSD (solid state drive), and a tertiary storage device such as an optical disc or an SD card. Memory 24 may also include the other storage devices. Memory 24 may be a nonvolatile memory, or may be a volatile memory.

Communication unit 25 is an external device including server 10 or a communication adapter capable of communicating with an external system. Communication unit 25 can communicate with an apparatus cooperation system such as a refrigerator, for example. In other words, information terminal 20 can cooperate with an apparatus cooperation system.

The communication method performed by communication unit 25 is a communication method such as a WAN (wide area network), a LAN (local area network), power line communications, infrared communications, short-distance-radio communications (e.g., Bluetooth (registered trademark)), or mobile communications for mobile phone, for example.

As mentioned above, cooking recipe display system 100 is provided with extraction unit 21a, emphasis unit 21b, and output unit 23. Extraction unit 21a extracts one or more recipe terms from natural language sentences constituting one cooking recipe selected from a plurality of cooking recipes stored in database 11. Emphasis unit 21b determines an emphasis method for the one or more recipe terms extracted by extraction unit 21a. Output unit 23 outputs the one cooking recipe, which are selected mentioned above, with the one or more recipe terms emphasized according to the emphasis method determined by emphasis unit 21b.

Thus, each recipe term, which is included as an element of the cooking recipe, can be highlighted by using a color or the like. Accordingly, a recipe term is decorated by a color or the like to display an entire cooking recipe. Therefore, a summary of the cooking recipe can be grasped without reading sentences of the entire cooking recipe in detail. As a result, a suitable display for each user can be performed.

A cooking recipe including the highlighted recipe terms can be displayed on a display screen at an optional timing. For instance, a cooking recipe including the highlighted recipe terms may be displayed on a display screen when a user cooks. The cooking recipe may be displayed on a display screen when a user searches for cooking, or may be displayed on a display screen in the other scenes.

### Concrete Example of Highlighting in Recipe Term

Next, when a recipe term included in a cooking recipe is highlighted using cooking recipe display system 100, the concrete examples thereof will be described. In the following concrete examples, an emphasis method is a color. In other words, a recipe term is highlighted by using a color. In the drawing, however, color classification of a recipe term is expressed by hatching, for convenience. In other words, different hatching means a different color.

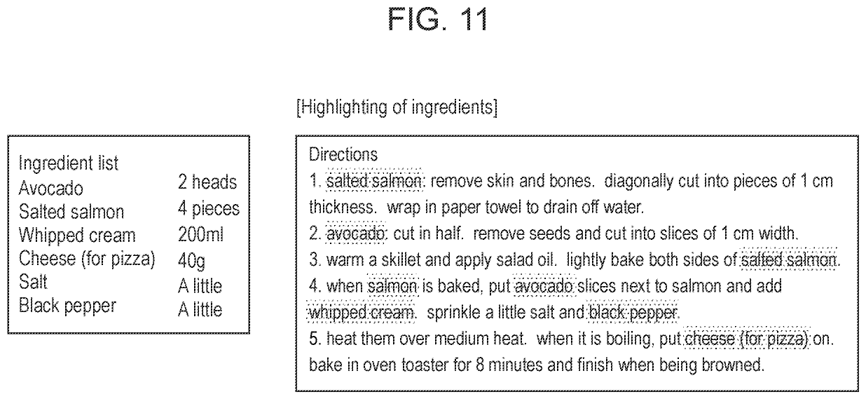

FIG. 11 exemplarily shows the case where a recipe term of “ingredients,” which is included in directions of a cooking recipe, is highlighted. For instance, in the example shown in FIG. 11, controller 21 refers to classification table 12 shown in FIG. 5 and emphasis table 14 shown in FIG. 7. As a result, output unit 23 highlights characters of “SALTED SALMON,” “AVOCADO,” “WHIPPED CREAM,” “SALMON,” “SALT,” “BLACK PEPPER,” and “CHEESE (FOR PIZZA),” which are extracted as a recipe term of ingredients, in red.

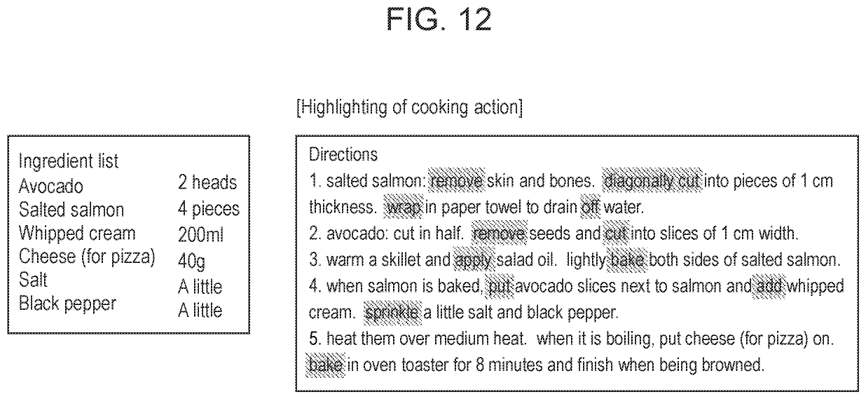

FIG. 12 exemplarily shows the case where a recipe term of “cooking action,” which is included in directions of a cooking recipe, is highlighted. For instance, in the example shown in FIG. 12, controller 21 refers to classification table 12 shown in FIG. 5 and emphasis table 14 shown in FIG. 7. As a result, output unit 23 highlights characters of “REMOVE,” “DIAGONALLY CUT,” “WRAP,” “DRAIN OFF,” “REMOVE,” “APPLY,” “PUT,” “ADD,” “SPRINKLE,” and “BAKE” in blue.

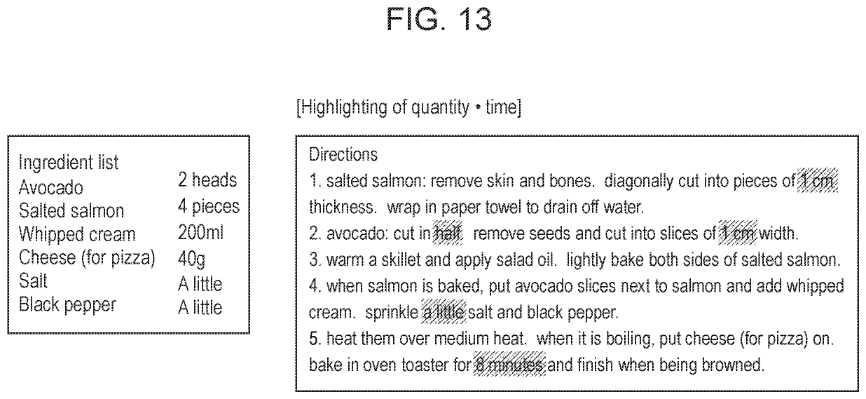

FIG. 13 exemplarily shows the case where a recipe term of “quantity” or “time,” which is included in directions of a cooking recipe, is highlighted. For instance, in the example shown in FIG. 13, controller 21 refers to classification table 12 shown in FIG. 5 and emphasis table 14 shown in FIG. 7. As a result, output unit 23 highlights characters of “1 cm,” “HALF,” “A LITTLE,” and “8 MINUTES,” which are extracted as quality and time of a cooking recipe, in green.

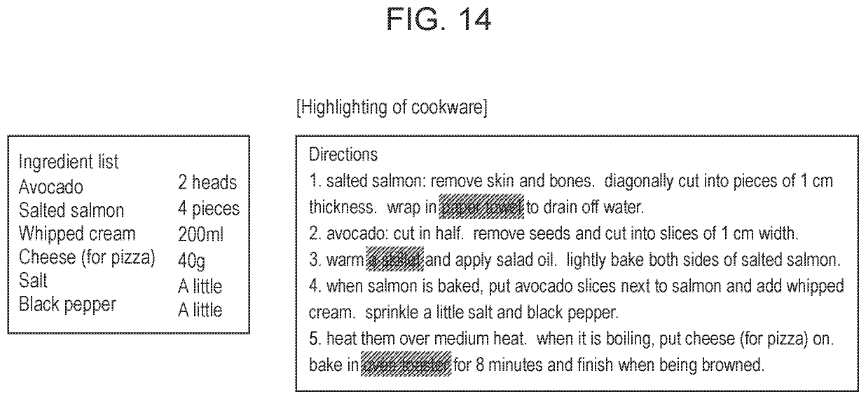

FIG. 14 exemplarily shows the case where a recipe term of “cookware,” which is included in directions of a cooking recipe, is highlighted. For instance, in the example shown in FIG. 14, controller 21 refers to classification table 12 shown in FIG. 5 and emphasis table 14 shown in FIG. 7. As a result, output unit 23 highlights characters of “PAPER TOWEL,” “SKILLET,” and “OVEN TOASTER,” which are extracted as a recipe term of cookware in a cooking recipe, in orange.

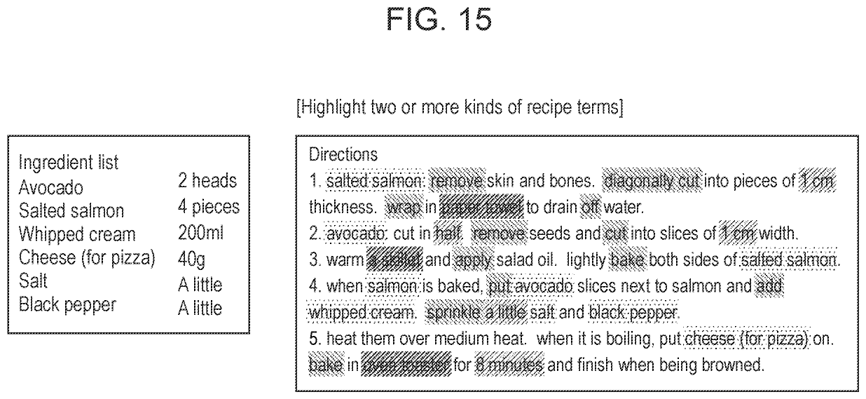

FIG. 15 exemplarily shows the case where two or more kinds of recipe terms are highlighted. Specifically, in the example shown in FIG. 15, emphasis methods (display rules) of highlighting shown in FIGS. 11 through 14 are combined. Accordingly, in the example shown in FIG. 15, output unit 23 highlights each of the recipe terms of “ingredients,” “cooking action,” “quality” (or “time”), and “cookware,” which are included in directions of a cooking recipe, in the emphasis methods shown in FIGS. 11 through 14 according to the types of recipe term classifications.

In the present exemplary embodiment, as shown in FIGS. 11 through 15, the recipe terms, such as “ingredients,” included in directions of a cooking recipe are highlighted, thereby making it possible to grasp contents of the cooking recipe easily. A plurality of recipe terms are highlighted in different emphasis methods (different colors in FIG. 15) according to the types of recipe term classifications, thereby making it possible to grasp a cooking recipe point easily for each of the recipe term classifications.

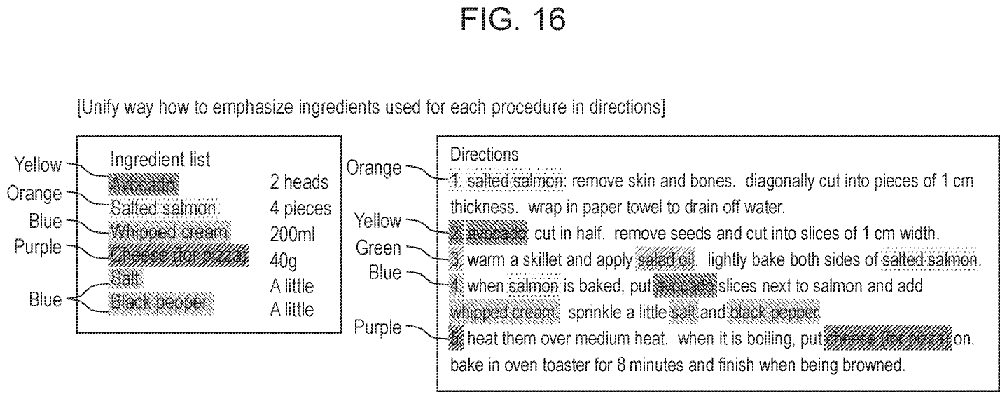

FIG. 16 exemplarily shows the case where emphasis methods of ingredients are unified for each procedure in directions of a cooking recipe to highlight recipe terms.

In this case, extraction unit 21a extracts at least a plurality of foods from natural language sentences, which constitute one cooking recipe selected by a user, as a recipe term. For the plurality of foods extracted by extraction unit 21a, emphasis unit 21b determines that an emphasis method for an n-th food, which is described in an n-th procedure (n is a natural number equal to or more than one) among a plurality of procedures included in directions of a cooking recipe, is set to an n-th emphasis method. Output unit 23 outputs the selected one cooking recipe such that an emphasis method for the n-th food described in a n-th procedure and an (n+1)th and subsequent procedures among the plurality of procedures is set to the above-mentioned n-th emphasis method.

For instance, in the example shown in FIG. 16, output unit 23 highlights heading numbers of procedure 1, procedure 2, procedure 3, procedure 4, and procedure 5 in orange, yellow, green, blue, and purple, respectively. Along with that, output unit 23 highlights a recipe term of “foods,” which is initially described in directions, in a color corresponding to a procedure in which the recipe term is described. When the recipe term appears again in the subsequent procedures, output unit 23 highlights the recipe term in the color corresponding to an emphasis method of the procedure in which the recipe term is initially described.

Specifically, output unit 23 highlights characters of “SALTED SALMON,” which are initially described in procedure 1, in orange corresponding to an emphasis method of procedure 1. In output unit 23, the characters of “SALTED SALMON,” which appear again in procedure 3, and characters of “SALMON,” which appear again in procedure 4, are not highlighted in green and blue, each corresponding to a corresponding one of emphasis methods of procedure 3 and procedure 4. Output unit 23 highlights these characters in orange corresponding to the emphasis method of procedure 1 in which the characters of “SALTED SALMON ” are initially described. Controller 21 determines that “SALMON” in procedure 4 has the same meaning as “SALTED SALMON” on terminological variation table 13.

Similarly to “AVOCADO,” output unit 23 highlights characters of “AVOCADO,” which are initially described in procedure 2, in yellow corresponding to an emphasis method of procedure 2. Output unit 23 does not highlight the characters of “AVOCADO,” which appear again in procedure 4, in blue corresponding to an emphasis method of procedure 4. Output unit 23 highlights these characters in yellow corresponding to the emphasis method of procedure 2 in which the characters of “AVOCADO” are initially described.

Characters of “SALAD OIL,” “WHIPPED CREAM,” “BLACK PEPPER,” and “CHEESE (FOR PIZZA)” each are described only once in directions of the cooking recipe. Accordingly, output unit 23 highlights these characters in the colors each corresponding to a corresponding one of emphasis methods of the procedures in which these recipe terms are described. In the example shown in FIG. 16, output unit 23 highlights not only “foods” in the directions but also “foods” in the ingredient list.

In the present exemplary embodiment, emphasis methods of ingredients are unified for each procedure in directions of a cooking recipe. Thus, when scrolling directions displayed on a display screen, a user can easily grasp a procedure to which the user should return. A display screen of information terminals 20, such as a smart phone, is typically small. Therefore, the entire cooking recipe can hardly be displayed simultaneously on the display screen with normal size characters visible for a user. It is necessary for a user to swipe the display screen to browse a cooking recipe, while scrolling it. When scrolling a cooking recipe to view the second half procedure, a user may fail to know where the user is required to return in order to browse the contents described in the first half procedure. It may be difficult to know whether the food described in the procedure is the one that has already been described or initially described in the procedure. In the present exemplary embodiment, the highlighting as shown in FIG. 16 makes it possible for a user to grasp a procedure to which the user should return easily, in these cases.

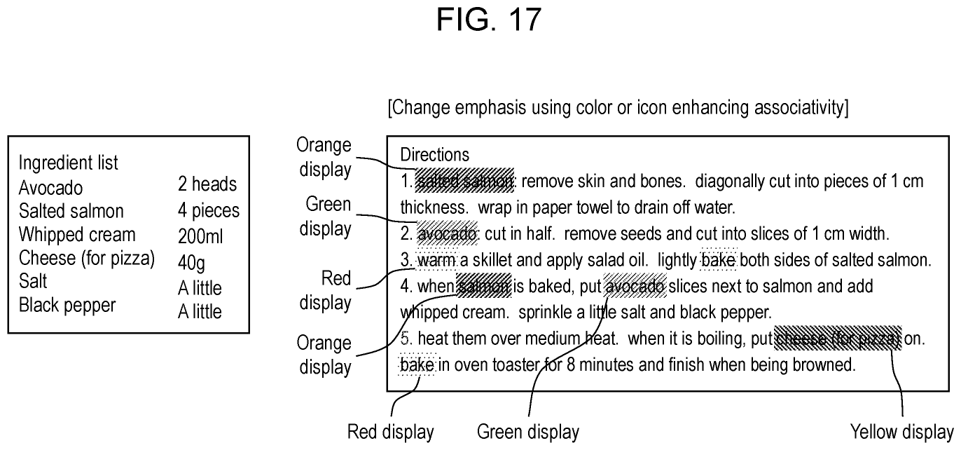

FIG. 17 shows the case where a recipe term is highlighted in a color that enhances associativity from the recipe term of a cooking recipe.

In this case, emphasis unit 21b determines an emphasis method for a plurality of recipe terms extracted by extraction unit 21a, with reference to association emphasis table 15 shown in FIG. 10. In FIG. 10, association emphasis table 15 defines a color associated with a recipe term. In other words, an emphasis method for each of one or more recipe terms extracted by extraction unit 21a is a color associated with the recipe term. The emphasis method for each of one or more recipe terms extracted by extraction unit 21a is not limited to a color, but may be an icon associated with the recipe term, or the like.

Specifically, in the example shown in FIG. 17, extraction unit 21a extracts recipe terms, such as “salted salmon,” “salmon,” “avocado,” “warm,” “bake,” and “cheese (for pizza),” as “foods” of a cooking recipe. Output unit 23 highlights these recipe terms in orange, green, red, and yellow each being a color related to a corresponding one of the recipe terms.

In the present exemplary embodiment, a recipe term of a cooking recipe is highlighted by using a color, an icon, or the like that enhances associativity from the recipe term. This makes it easy for a user to image a type of the highlighted recipe term, or the like, intuitively. Thus, the user can understand contents of a cooking recipe easily.

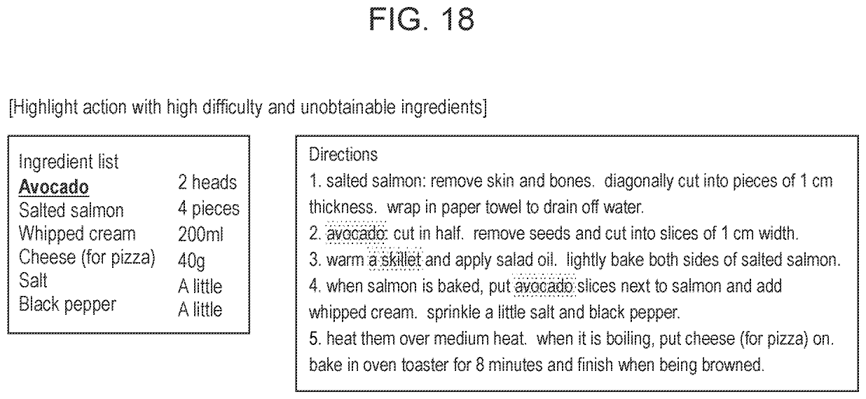

FIG. 18 exemplarily shows the case where a recipe term related to cooking action with relatively high difficulty and unobtainable ingredients is highlighted.

The example shown in FIG. 18 shows the case where one or more recipe terms, which are extracted by extraction unit 21a, include at least one of cooking action with relatively high difficulty, unobtainable ingredients, or unobtainable cookware. In this case, the emphasis unit 21b determines an emphasis method for the at least one of cooking action with relatively high difficulty, unobtainable ingredients, or unobtainable cookware.

Specifically, in the example shown in FIG. 18, the recipe terms extracted by extraction unit 21a include characters of “AVOCADO” as a recipe term of unobtainable ingredients. Furthermore, these recipe terms include characters of “SKILLET” as a recipe term of unobtainable cookware. In this case, emphasis unit 21b changes the color of characters of “AVOCADO” and “SKILLET.”

Thus, when viewing a cooking recipe to search for a dish, a user can easily determine whether this dish can be made easily or not. As shown in FIG. 18, by browsing the highlighted cooking recipe, a user can grasp unobtainable ingredients and cookware, easily. Accordingly, to determine a dish to be cooked, a user can refer to information indicating whether ingredients and cookware are unobtainable or not. If a user is notified, in advance, of ingredients and cookware to be necessary in cooking, the user will enable to prepare the ingredients and cookware, as necessary, before cooking.

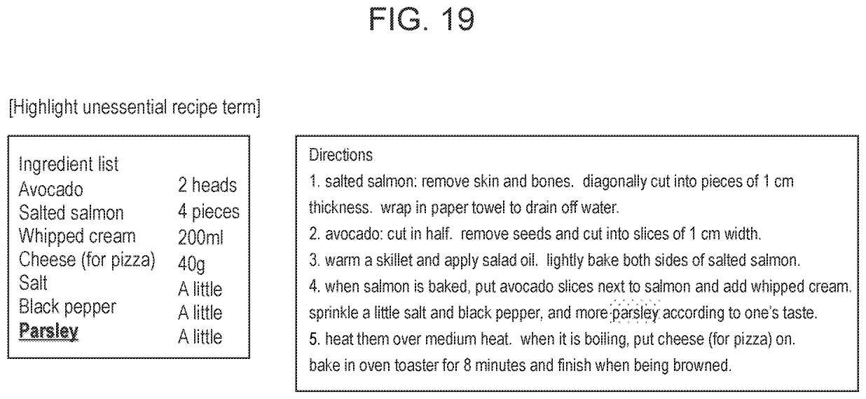

FIG. 19 exemplarily shows the case where a recipe term related to ingredients, cookware, and the like, which are not essential for dishes included in a cooking recipe, is highlighted.

Specifically, the example shown in FIG. 19 shows the case where natural language sentences of one cooking recipe, which is selected by a user, include an optional term that is not essential for dishes made by using the one cooking recipe. In this case, extraction unit 21a extracts a recipe term corresponding to the optional term from the natural language sentences constituting the selected one cooking recipe. In other words, extraction unit 21a extracts a recipe term having a modifier that expresses the optional term. Emphasis unit 21b determines an emphasis method for a recipe term corresponding to the optional term extracted by extraction unit 21a. According to the emphasis method determined by emphasis unit 21b, controller 21 emphasizes the recipe term corresponding to the optional term, and causes output unit 23 to display the above-mentioned one cooking recipe.

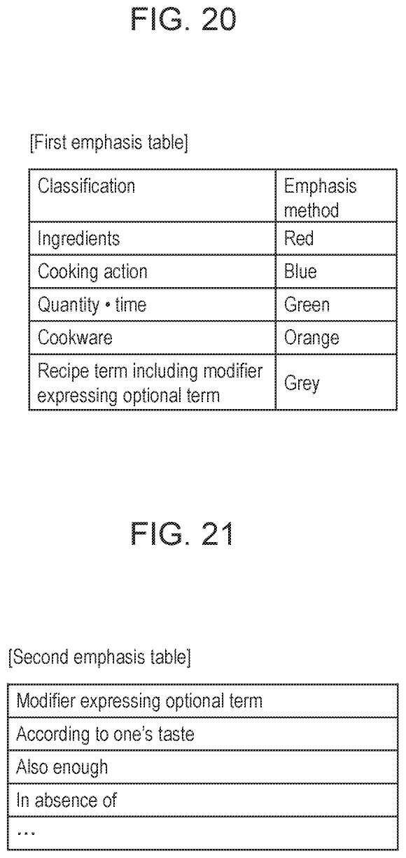

Specifically, extraction unit 21a extracts an optional term from natural language sentences constituting the selected one cooking recipe, with reference to the emphasis tables shown in FIGS. 20 and 21. Furthermore, extraction unit 21a extracts a recipe term modified by this optional term. In the example shown in FIG. 19, characters of “ACCORDING TO ONE'S TASTE ” are included in directions of the cooking recipe as the optional term. Accordingly, extraction unit 21a extracts characters of “PARSLEY” as a recipe term modified by the characters of “ACCORDING TO ONE'S TASTE.” According to the first emphasis table shown in FIG. 20, emphasis unit 21b determines a color as an emphasis method for the extracted characters of “PARSLEY.” Output unit 23 highlights the characters of “PARSLEY” according to the determined color. As shown in FIG. 20, according to the emphasis method for a recipe term having a modifier that expresses an optional term, the characters of “PARSLEY” is highlighted in gray.

As an aspect of highlighting, output unit 23 may display the characters of “PARSLEY” with a light color or may display the characters with a dashed line.

According to the present exemplary embodiment, a recipe term of ingredients, cookware, or the like that is not essential for cooking is highlighted. Thus, a user can easily understand a recipe term of ingredients, cookware, or the like that is not necessarily required for cooking.

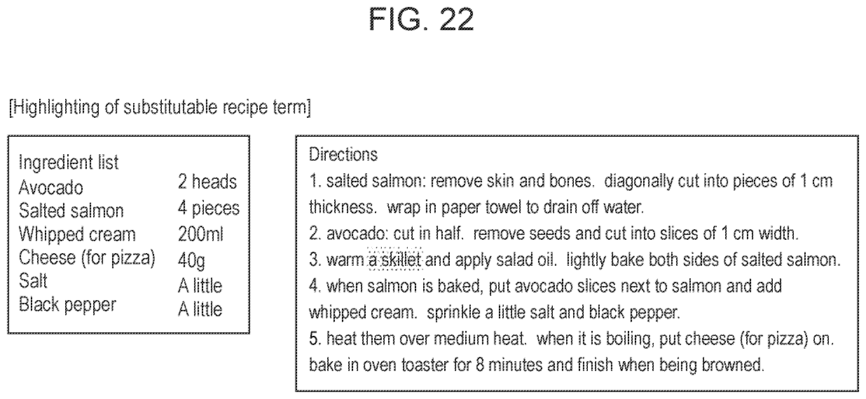

FIG. 22 exemplarily shows the case where a substitutable recipe term included in a cooking recipe is highlighted.

The example shown in FIG. 22 shows the case where natural language sentences of one cooking recipe, which is selected by a user, include a substitutable recipe term, which can be substituted by other objects or other matters, as a recipe term. In this case, extraction unit 21a extracts a substitutable recipe term from the natural language sentences constituting the above-mentioned one cooking recipe. The emphasis unit 21b determines an emphasis method for the substitutable recipe term extracted by extraction unit 21a. According to the emphasis method determined by emphasis unit 21b, controller 21 emphasizes the substitutable recipe term, and causes output unit 23 to display the above-mentioned one cooking recipe.

Specifically, extraction unit 21a extracts a substitutable recipe term from natural language sentences constituting the selected one cooking recipe, with reference to the substitutable term table shown in FIG. 9. In the example shown in FIG. 22, characters of “SKILLET” are included in directions of the cooking recipe as a substitutable recipe term. Accordingly, extraction unit 21a extracts the characters of “SKILLET” as a substitutable recipe term. Emphasis unit 21b determines a color as an emphasis method for the extracted characters of “SKILLET.” Output unit 23 highlights the characters of “SKILLET” according to the determined color.

By user's selection of the highlighted substitutable recipe term, the recipe term subjected to the substitution may be displayed on a display screen. For instance, in FIG. 22, when a user taps the characters of “SKILLET,” output unit 23 may display information, which indicates that substitutable cookware of “skillet” is “frying pan,” on a pop-up screen.

According to the present exemplary embodiment, a substitutable recipe term included in a cooking recipe is highlighted. Thus, a user can easily understand a recipe term of substitutable ingredients, substitutable cookware, or the like.

As a component for extracting an optional term (modifier) that modifies a recipe term, information terminal 20 may have a natural-language-processing unit instead of extraction unit 21a, or may further have the natural-language-processing unit in addition to extraction unit 21a.

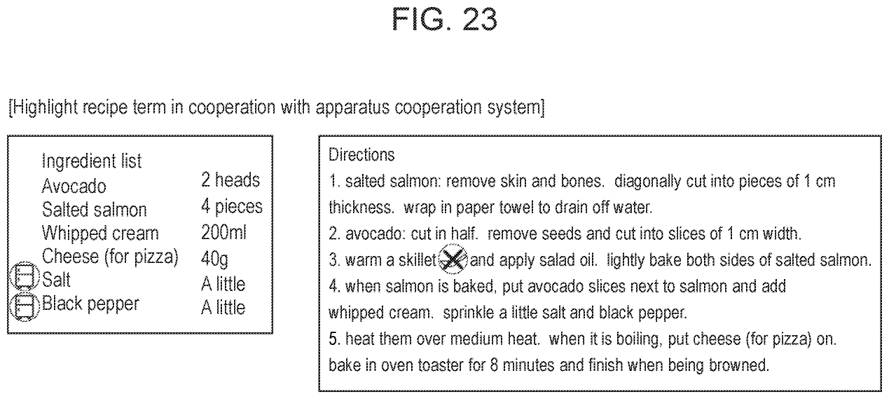

FIG. 23 exemplarily shows the case where a recipe term is highlighted in cooperation with an apparatus cooperation system. In the example shown in FIG. 23, cooking recipe display system 100 is in cooperation with an apparatus, such as a refrigerator, that has inventory information of ingredients. In other words, information terminal 20 cooperates with a refrigerator serving as an apparatus cooperation system.

In this case, based on the inventory information of ingredients, controller 21 determines whether the ingredients, which are extracted by extraction unit 21a as a recipe term, are currently stocked in the refrigerator or not. Emphasis unit 21b determines an emphasis method for the ingredients according to the above-mentioned determination. According to the emphasis method determined by emphasis unit 21b, controller 21 emphasizes the ingredients, which are extracted by extraction unit 21a, and causes output unit 23 to display the cooking recipe.

For instance, as shown in FIG. 23, output unit 23 highlights these recipe terms such that it is understood that “salt” and “black pepper” in the ingredient list are stocked in a refrigerator, based on inventory information of ingredients. The example shown in FIG. 23 shows the case where a user does not possess a “skillet.” In this case, “SKILLET” is highlighted such that it is understood that a user does not possess a “skillet.” The user may record in advance cookware, such as a skillet, in an apparatus cooperation system or cooking recipe display system 100. In FIG. 23, the emphasis method of a recipe term is an icon arranged around the recipe term, but may be a color of characters or the like.

According to the present exemplary embodiment, a recipe term in cooperation with an apparatus cooperation system is highlighted. Thus, a user can easily understand inventory information on a recipe term included in a cooking recipe.

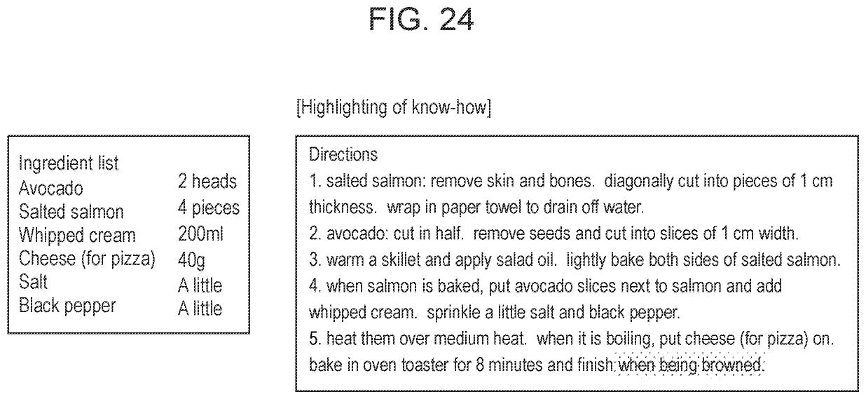

FIG. 24 exemplarily shows the case where cooking know-how included in a cooking recipe is highlighted.

The example shown in FIG. 24 shows the case where natural language sentences of one cooking recipe, which is selected by a user, include an expression related to know-how. In this case, extraction unit 21a extracts a recipe term related to know-how from the natural language sentences constituting the above-mentioned one cooking recipe. Emphasis unit 21b determines an emphasis method for the recipe term related to know-how extracted by extraction unit 21a. According to the emphasis method determined by emphasis unit 21b, controller 21 emphasizes the recipe term related to know-how, and causes output unit 23 to display the above-mentioned one cooking recipe.

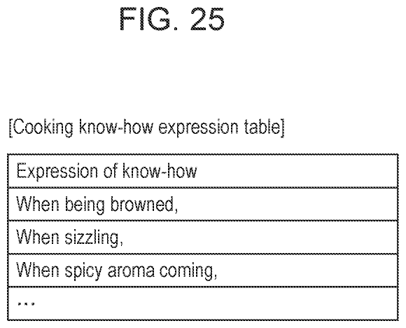

Specifically, extraction unit 21a extracts a substitutable recipe term from natural language sentences constituting the selected one cooking recipe, with reference to a cooking know-how expression table shown in FIG. 25. In the example shown in FIG. 24, characters of “WHEN BEING BROWNED” are included in directions of the cooking recipe as a recipe term related to know-how. Accordingly, extraction unit 21a extracts the characters of “WHEN BEING BROWNED.” Emphasis unit 21b determines a color as an emphasis method for the characters of “WHEN BEING BROWNED.” Output unit 23 highlights the characters of “WHEN BEING BROWNED” according to the determined color.

According to the present exemplary embodiment, cooking know-how included in a cooking recipe is highlighted. Thus, a user can easily know the cooking know-how.

When a user selects an expression (characters or the like) related to cooking know-how that is highlighted on a display screen, an explanatory note of the cooking know-how may be displayed on the display screen. Thus, a user can know contents of the cooking know-how easily.

### OTHER MODIFICATIONS

As mentioned above, the present disclosure has been described based on the exemplary embodiments, but the present disclosure is not limited to the above-mentioned exemplary embodiments.

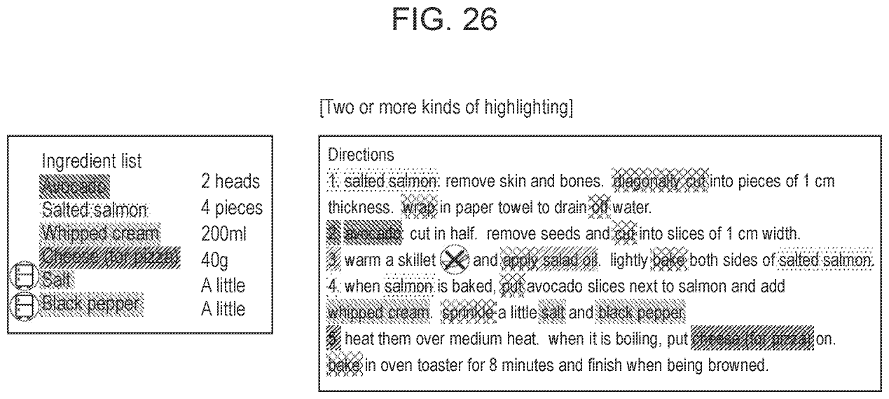

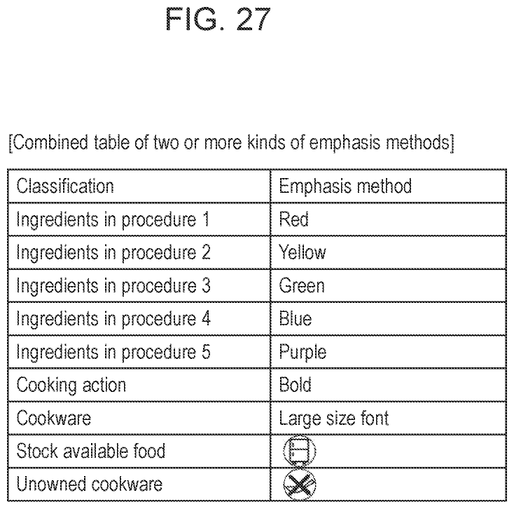

For instance, the concrete examples of highlighting shown in FIGS. 11 through 25 each have one kind of emphasis method (display rule). However, the present disclosure is not limited to this. Specifically, emphasis unit 21b may combine two or more kinds of emphasis methods, as shown in FIG. 26. In this case, as shown in FIG. 27, extraction unit 21a uses a table in which two or more kinds of emphasis methods are combined.

Since it is enough to emphasize the characters required to be emphasized, a background color is not limited to white. If a background color is black, the characters required to be emphasized may be displayed in yellow, and the characters may be displayed with bold letters.

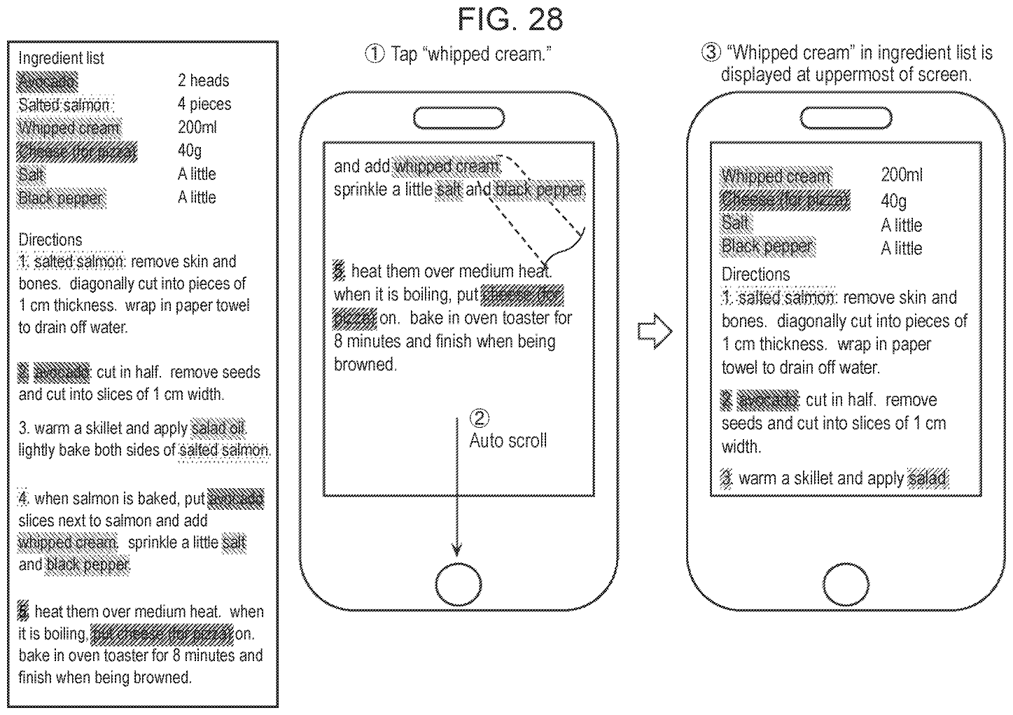

In cooking recipe display system 100, when a user selects the highlighted ingredients or quantity included in directions of a cooking recipe, an ingredient list may be displayed on a display screen. For instance, as shown in FIG. 28, when a user taps characters of “WHIPPED CREAM,” which are highlighted on a display screen of information terminal 20, the display screen may be scrolled upward automatically. As a result, “WHIPPED CREAM” listed in the ingredient list may be displayed on an upper part (uppermost part in FIG. 28) of the display screen. In other words, when a user taps a highlighted ingredient on the display screen, the ingredient will be displayed on an uppermost part of the display screen.

In the above-mentioned exemplary embodiment, emphasis unit 21b determines an emphasis method related to a character or a picture. However, the present disclosure is not limited to this. For instance, emphasis unit 21b may determine an emphasis method related to sound. In this case, the emphasis method is at least one of loudness, sound pitch, sound tone, sound intonation, or the number of times of sound reproduction, for example. Output unit 23 is a speaker. According to the emphasis method determined by emphasis unit 21b, the speaker outputs one cooking recipe with the one or more recipe terms emphasized by using sound. In this case, information terminal 20 may cause a display unit to highlight the recipe term, while emphasizing the recipe term by using sound.

In the above-mentioned exemplary embodiment, a type of recipe term classification, a recipe term to be highlighted, a terminological variation term, and an emphasis method (color or the like) associated with a recipe term each are previously set in a corresponding one of the tables of server 10. However, a user may download information on each table of server 10 to store it in memory 24. After that, the information on each table may be changed suitably in information terminal 20.

Furthermore, information terminal 20 may have database 11 as well as these tables. In other words, information terminal 20 may have at least one or all of database 11, classification table 12, terminological variation table 13, emphasis table 14, and association emphasis table 15.

In the above-mentioned exemplary embodiment, a cooking recipe including highlighted recipe terms is displayed on information terminal 20. However, the present disclosure is not limited to this. For instance, electric home appliances, such as a microwave oven and a refrigerator, may have a display screen for displaying a cooking recipe including highlighted recipe terms. In other words, in FIGS. 1 and 2, information terminal 20 may be electric home appliances such as a microwave oven and a refrigerator. In this case, when operating an input unit installed in these electric home appliances, a user can browse the cooking recipe displayed on a display screen installed in these electric home appliances.

Another aspect of the present disclosure is a cooking recipe display method. In the cooking recipe display method of the aspect, one or more recipe terms are extracted from natural language sentences constituting one cooking recipe selected from a plurality of cooking recipes each being expressed in natural language sentences. An emphasis method is determined for the extracted one or more recipe terms. According to the determined emphasis method, the extracted one or more recipe terms, mentioned above, are emphasized, and the selected one cooking recipe, mentioned above, is outputted.

Still another aspect of the present disclosure is a program for causing a computer to execute the above-mentioned cooking recipe display method. The program is stored in a readable recording medium by the computer. The recording medium may be memory 24 in cooking recipe display system 100, or may be various kinds of external storage devices.

### INDUSTRIAL APPLICABILITY

As mentioned above, the cooking recipe display system in accordance with the present disclosure is applicable to electric home appliances such as a microwave oven and a refrigerator.

### REFERENCE MARKS IN THE DRAWINGS

10 server

11 database

12 classification table

13 terminological variation table

14 emphasis table

15 association emphasis table

20 information terminal

21 controller

21a extraction unit

21b emphasis unit

22 input unit

23 output unit

24 memory

25 communication unit

100 cooking recipe display system

1. A cooking recipe display system comprising:
a database that stores a plurality of cooking recipes each being expressed in natural language sentences;
an extraction unit operable to extract one or more recipe terms from natural language sentences constituting one cooking recipe selected from the plurality of cooking recipes stored in the database;
an emphasis unit operable to determine an emphasis method for the one or more recipe terms; and
an output unit operable to output the one cooking recipe with the one or more recipe terms emphasized according to the emphasis method determined by the emphasis unit.

2. The cooking recipe display system according to claim 1, wherein
the extraction unit is operable to extract a plurality of recipe terms from the natural language sentences constituting the one cooking recipe,
the emphasis unit is operable to determine an emphasis method for each of the plurality of recipe terms extracted by the extraction unit, and
the output unit is operable to output the one cooking recipe with each of the plurality of recipe terms emphasized according to the emphasis method determined by the emphasis unit.

3. The cooking recipe display system according to claim 2, further comprising:
a recipe term classification table that includes a plurality of recipe term classifications classified in advance according to a type of recipe term; and
a recipe term emphasis table that includes a plurality of emphasis methods determined in advance for each of the plurality of recipe term classifications,
wherein:
the emphasis unit is operable to classify the plurality of recipe terms according to the plurality of recipe term classifications with reference to the recipe term classification table, the plurality of recipe terms being extracted by the extraction unit, and determine an emphasis method for each of the plurality of recipe terms with respect to each of the plurality of recipe term classifications with reference to the recipe term emphasis table; and
the output unit is operable to output the one cooking recipe with each of the plurality of recipe terms emphasized according to the emphasis method determined by the emphasis unit.

4. The cooking recipe display system according to claim 1, wherein
the one or more recipe terms extracted by the extraction unit include ingredient information.

5. The cooking recipe display system according to claim 1, wherein
the one or more recipe terms extracted by the extraction unit include cooking action information.

6. The cooking recipe display system according to claim 1, wherein
the one or more recipe terms extracted by the extraction unit include at least one of a quantity of ingredients or cooking time.

7. The cooking recipe display system according to claim 1, wherein
the one or more recipe terms extracted by the extraction unit include cookware information.

8. The cooking recipe display system according to claim 1, wherein
the emphasis method determined by the emphasis unit is any one of a character color, a character thickness, a character size, a character font, and decoration insertion of an alternative icon,
the output unit is a display unit, and
the display unit displays the one cooking recipe with the one or more recipe terms emphasized by using a text according to the emphasis method determined by the emphasis unit.

9. The cooking recipe display system according to claim 1, wherein
the emphasis method determined by the emphasis unit is at least one of loudness, sound pitch, sound tone, sound intonation, or a numerical quantity of times of sound reproduction,
the output unit is a speaker, and
the speaker outputs the one cooking recipe with the one or more recipe terms emphasized by using sound according to the emphasis method determined by the emphasis unit.

10. The cooking recipe display system according to claim 1, further comprising:
a recipe term terminological variation table that includes a plurality of terminological variation terms with respect to a natural language of one standard recipe term,
wherein:
the emphasis unit is operable to specify which standard recipe term is each of the one or more recipe terms with reference to the recipe term terminological variation table, the one or more recipe terms being extracted by the extraction unit; and
the emphasis unit is operable to determine an emphasis method for each of the one or more recipe terms extracted by the extraction unit such that, among the one or more recipe terms extracted by the extraction unit, a recipe term specified as an identical standard recipe term is emphasized according to an identical emphasis method.

11. The cooking recipe display system according to claim 1, wherein:
the one cooking recipe includes a plurality of procedures indicating directions of cooking;
the extraction unit is operable to extract at least a plurality of foods from the natural language sentences constituting the one cooking recipe as a recipe term;
the emphasis unit is operable to determine that an emphasis method for an n-th food is set to an n-th emphasis method for the plurality of foods extracted by the extraction unit, the n-th food being described in an n-th procedure (n is one or more natural numerals) among the plurality of procedures; and
the output unit is operable to output the one cooking recipe such that an emphasis method for the n-th food is set to the n-th emphasis method, the n-th food being described in the th procedure and an (n+1)th and subsequent procedures among the plurality of procedures.

12. The cooking recipe display system according to claim 1, wherein
the emphasis method for each of the one or more recipe terms extracted by the extraction unit is a color or an icon associated with the each of the one or more recipe terms.

13. The cooking recipe display system according to claim 1, wherein
each of the one or more recipe terms includes at least one of cooking action, foods, or cookware, and
when the one or more recipe terms extracted by the extraction unit includes at least one of cooking action with relatively high difficulty, an unobtainable ingredient, or unobtainable cookware, the emphasis unit is operable to determine an emphasis method for the at least one of cooking action with relatively high difficulty, an unobtainable ingredient, or unobtainable cookware.

14. The cooking recipe display system according to claim 1, further comprising
an input unit that accepts an input of a user,
wherein
the input unit is operable to accept an emphasis method for a recipe term from the user, and
the emphasis unit is operable to determine an emphasis method for the one or more recipe terms according to the emphasis method accepted in the input unit, the one or more recipe terms being extracted by the extraction unit.

15. The cooking recipe display system according to claim 1, wherein
the emphasis unit is operable to determine an emphasis method for the one or more recipe term according to a cooking skill of a user, the one or more recipe term being extracted by the extraction unit.

16. The cooking recipe display system according to claim 1, wherein
the cooking recipe includes directions of cooking and an ingredient list,
the output unit is a display unit, and
the display unit displays the ingredient list when a user selects ingredients or quantity highlighted on the display unit, the ingredients or quantity being included in the directions of the cooking recipe.

17. The cooking recipe display system according to claim 1, wherein
an expression related to cooking know-how is included as the recipe term,
the output unit is a display unit, and
when a user selects the expression related to cooking know-how that is highlighted on the display unit, the display unit displays an explanatory note of the cooking know-how.

18. The cooking recipe display system according to claim 1, wherein:
when an optional term is included in natural language sentences of the one cooking recipe, the optional term being a term that is unessential and optional for dishes cooked by using the one cooking recipe,
the extraction unit is operable to extract a recipe term corresponding to the optional term from the natural language sentences constituting the one cooking recipe;
the emphasis unit is operable to determine an emphasis method for the recipe term corresponding to the optional term, the recipe term being extracted by the extraction unit; and
the output unit is operable to output the one cooking recipe with the recipe term corresponding to the optional term emphasized according to the emphasis method determined by the emphasis unit.

19. The cooking recipe display system according to claim 1, wherein:
when a substitutable recipe term is included in natural language sentences of the one cooking recipe as the recipe term, the substitutable recipe term being a term that is allowed to be substituted by other objects or other matters,
the extraction unit is operable to extract the substitutable recipe term from the natural language sentences constituting the one cooking recipe;
the emphasis unit is operable to determine an emphasis method for the substitutable recipe term extracted by the extraction unit; and
the output unit is operable to output the one cooking recipe with the substitutable recipe term emphasized according to the emphasis method determined by the emphasis unit.

20. The cooking recipe display system according to claim 1, wherein:
the cooking recipe display system is in cooperation with an apparatus that has inventory information of ingredients;
the emphasis unit is operable to determine an emphasis method for ingredients according to existence of inventory of the ingredients based on the inventory information of ingredients from the apparatus, the ingredients being extracted by the extraction unit as the recipe term; and
the output unit is operable to output the one cooking recipe with the ingredients emphasized according to the emphasis method determined by the emphasis unit.

21. A cooking recipe display method comprising:
extracting one or more recipe terms from natural language sentences constituting one cooking recipe selected from a plurality of cooking recipes each being expressed in the natural language sentences;
determining an emphasis method for the one or more recipe terms that are extracted; and
outputting the one cooking recipe with the one or more recipe terms emphasized according to the determined emphasis method.

22. A program for causing a computer to execute the cooking recipe display method according to claim 21.

23. An information terminal comprising:
an extraction unit operable to extract one or more recipe terms from natural language sentences constituting one cooking recipe selected from a plurality of cooking recipes each being expressed in the natural language sentences;
an emphasis unit operable to determine an emphasis method for the one or more recipe terms; and
an output unit operable to output the one cooking recipe with the one or more recipe terms emphasized according to the emphasis method determined by the emphasis unit.
